(19) United States
(12) Patent Application Publication
(10) Pub. No.: US 2018/0142771 A1
(43) Pub. Date: May 24, 2018

(54) SYSTEM OF COMPONENTS HAVING WIRE WELD JOINT AND A METHOD OF JOINING A SYSTEM OF COMPONENTS INCLUDING A CAST IRON COMPONENT

(71) Applicant: GM GLOBAL TECHNOLOGY OPERATIONS LLC, Detroit, MI (US)

(72) Inventor: Shun X. Zhang, Canton, MI (US)

(21) Appl. No.: 15/360,072

(22) Filed: Nov. 23, 2016

(51) Int. Cl. F16H 48/40; B23K 26/00; B23K 26/211; F16H 48/08

(52) U.S. Cl. CPC F16H 48/40; B23K 26/0006; B23K 2201/006; F16H 48/08; B23K 26/211

(57) ABSTRACT

A system of components includes a first component including a first joint portion, and a second component including a second joint portion abutting the first component. At least one of the first and second components is formed from cast iron. The first joint portion and the second joint portion, when aligned, form a V-Shaped groove having a groove opening, a groove bottom angle of between about 10° and about 20° and a weld nugget envelope defined therebetween. The groove opening is wider than an outer diameter of a filler wire employed to form a metallurgical bond between the first component and the second component.

### FIELD OF THE INVENTION

The subject invention relates to the art of metallurgical bonds and, more particularly to a system of components having a wire weld joint and a method of joining a system of components including a cast iron component.

### BACKGROUND

Motor vehicles include numerous mechanical components that are joined through various techniques. Components can be joined through mechanical fasteners such as bolts, screws, clips and the like. Components may also be joined through chemical or metallurgical bonds such as those achieved through welding. Metallurgical bonds with cast iron components require special consideration. Welded joints associated with cast iron surfaces are prone to cracking.

In order to avoid cracking, a filler metal is used when welding cast iron components. Proper position of the filler metal relative to the joint is particularly important when the weld joint includes a generally J-shaped cross-section as is typically the case when laser welding cast iron. Occasionally, employing filler wire to weld cast iron will lead to less than desirable results due to wire placement and weld geometry. In some cases, the less than desirable results may include a lack of fusion between the filler wire and cast iron and/or a weak weld joint. Accordingly, it is desirable to provide a system for welding cast iron components with increased consistency in bond integrity.

### SUMMARY OF THE INVENTION

In accordance with an aspect of an exemplary embodiment, a system of components includes a first component including a first joint portion, and a second component including a second joint portion abutting the first component. At least one of the first and second components is formed from cast iron. The first joint portion and the second joint portion, when aligned, form a V-Shaped groove having a groove opening, a groove bottom angle of between about 10° and about 20° and a weld nugget envelope defined therebetween. The groove opening is wider than an outer diameter of a filler wire employed to form a metallurgical bond between the first component and the second component.

In accordance with another exemplary aspect, a vehicle differential includes a differential barrel component including a first joint portion. The differential barrel component is formed from cast iron. A ring gear component is mounted to the differential barrel component. The ring gear component includes a second joint portion. The first joint portion and the second joint portion, when aligned, form a V-Shaped groove having a groove opening, a groove bottom angle of between about 10° and about 20° and a weld nugget envelope defined therebetween. The groove opening is wider than an outer diameter of a filler wire employed to form a metallurgical bond between the first component and the second component.

In accordance with yet another exemplary aspect, a method of joining a system of components includes adjoining a first component including a first joint portion with a second component having a second joint portion. At least one of the first and second components is formed from cast iron. The first joint portion is aligned with the second joint portion forming a V-Shaped groove having a groove opening, a groove bottom angle of between about 10° and about 20° and a weld nugget envelope defined therebetween. A filler wire having an outer diameter smaller than the groove opening is inserted into the V-Shaped groove. The first component is metallurgically bonded to the second component including melting the filler wire into the V-Shaped groove.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 depicts a vehicle including a system of components shown in the form of a differential, in accordance with an exemplary embodiment;

FIG. 2 depicts a partially cut-away view of the differential of FIG. 1;

FIG. 3 depicts a cross-sectional view of the a differential barrel component of the differential of FIG. 2 illustrating a partially disassembled ring gear component; and

FIG. 4 depicts a cross-sectional view of the differential of FIG. 2 illustrating the ring gear component assembled to the differential barrel component forming a V-Shaped groove prior to welding;

FIG. 5 depicts a partial view of the differential and ring gear component illustrating the V-Shaped groove receiving a filler wire, in accordance with an exemplary embodiment; and

FIG. 6 depicts the ring gear component and differential after a welding operation.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

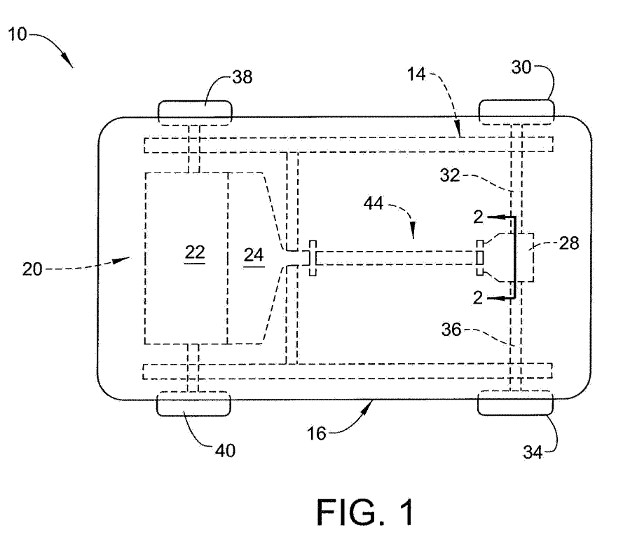

A vehicle, in accordance with an exemplary embodiment, is indicated generally at 10 in FIG. 1. Vehicle 10 includes a chassis 14 supporting a body 16. Chassis 14 also supports a drivetrain 20 including a engine 22, a transmission 24, and a rear differential 28. It is to be understood that engine 22 may take the form of an electric motor, an internal combustion engine, a hybrid electric motor, or other forms of prime movers that provide motive power to vehicle 10. Rear differential 28 is coupled to a first rear wheel 30 through a first axle 32 and to a second rear wheel 34 through a second axle 36. Vehicle 10 may also include first and second front wheels 38 and 40. It is also to be understood that while shown as having a rear wheel drive, other drive configurations including front wheel drive and four wheel drive may also be employed. Rear differential 28 is coupled to transmission 24 through a driveshaft 44.

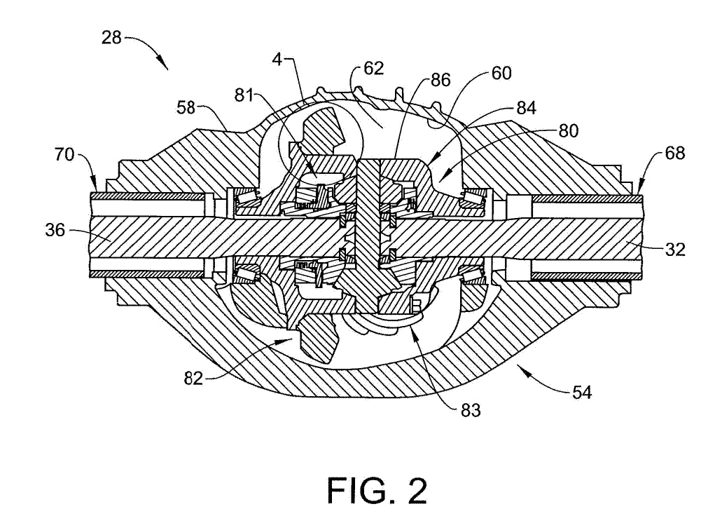

In accordance with an aspect of an exemplary embodiment, rear differential 28 includes a housing portion 54 having an outer surface 58 and an inner surface 60 that defines a gear receiving zone 62 as shown in FIG. 2. Housing portion 54 also supports a first axle tube 68 that surrounds first axle 32 and a second axle tube 70 that surrounds second axle 36. Gear receiving zone 62 houses a differential barrel component 80 that supports a planetary gear set 81 and a ring gear component 82. In accordance with an aspect of an exemplary embodiment, differential barrel component 80 may be formed from cast iron and ring gear component 82 may be formed from carbonized steel that is machined to a desired profile. Ring gear component 82 engages with a pinion 83 driven by driveshaft 44. Pinion 83 engages with ring gear component 82 to rotate differential barrel component 80 which in turn drives first and second axles 32 and 36 through the planetary gear set 81.

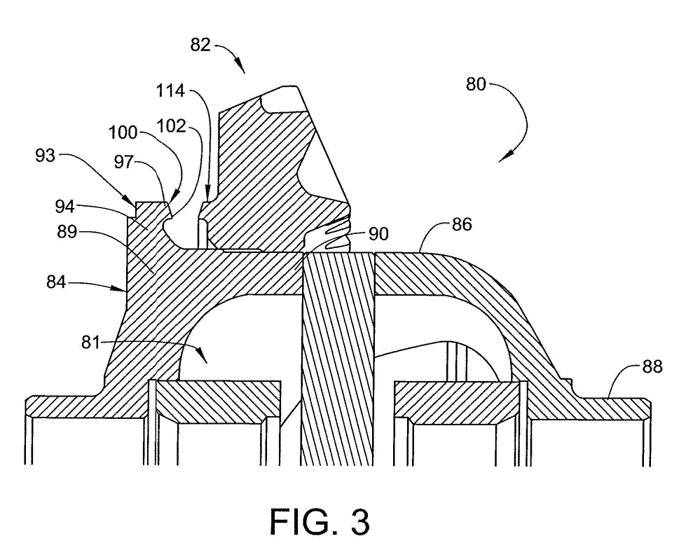

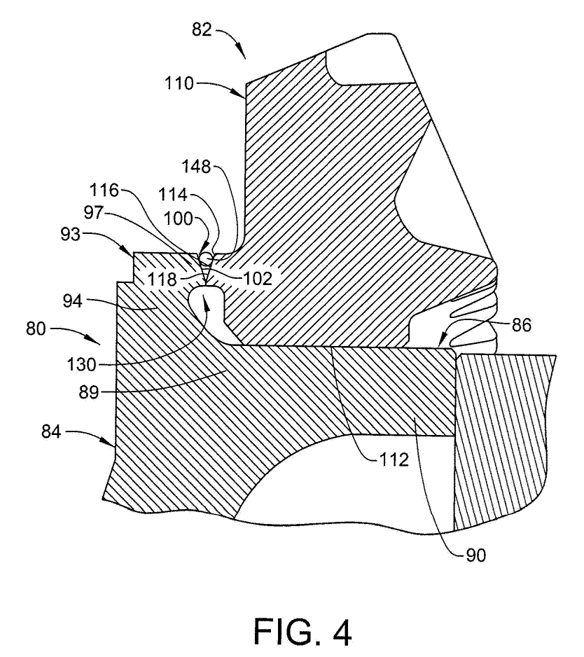

Reference will now follow to FIGS. 3 and 4 in describing differential barrel component 80 and ring gear component 82. Differential barrel component 80 includes a body 84 having an outer surface 86 including a first end 88, a second end 89, and an intermediate portion 90. Second end 89 includes a ring gear component support member 93 that provides a desired position of ring gear component 82 on body 84. Ring gear component support member 93 includes a radially outwardly projecting portion 94 that extends from body 84 at second end 89 and an axially projecting portion 97. In accordance with an aspect of an exemplary embodiment, axially projecting portion 97 includes a first joint portion 100 having a first angled surface 102.

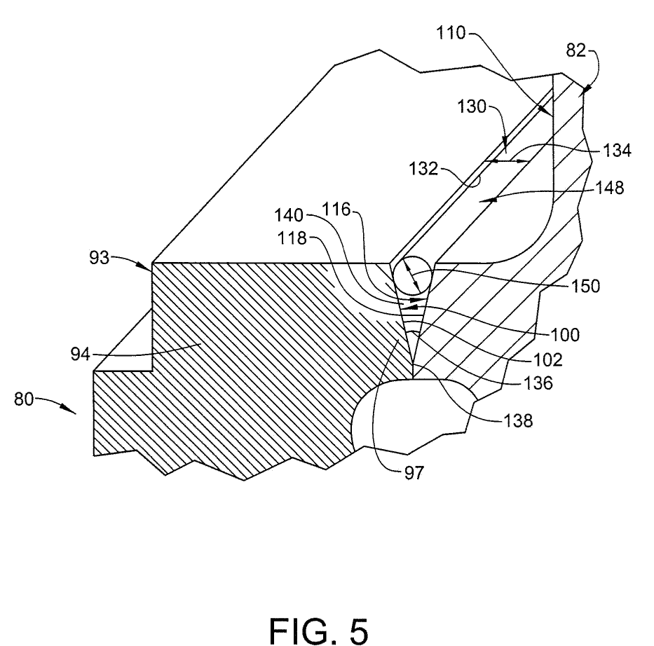

Ring gear component 82 may be positioned on body 84 abutting axial projecting portion 97 to establish a desired position on outer surface 86 (FIG. 2 and FIG. 4). In accordance with an aspect of an exemplary embodiment, ring gear component 82 includes a ring gear body 110 having an inner annular surface section 112, and an axial projecting element 114 that is positioned to align with and abut axial projection portion 97. Axial projecting element 114 includes a second joint portion 116 having a second angled surface 118. When ring gear component 82 is installed to differential barrel component 80 and axial projecting element 114 abuts axial projection portion 97, first joint portion 100 and second joint portion 116 combine to establish a V-Shaped groove 130 as shown in FIGS. 4 and 5.

In accordance with an aspect of an exemplary embodiment, V-Shaped groove 130 includes a groove opening 132 having a selected dimension 134. V-Shaped groove 130 also includes a groove bottom angle 136 defined by first angled surface 102 and second angled surface 118. First angled surface 102 and second angled surface 118 abut to form an apex 138 of groove bottom angle 136. In accordance with an aspect of an exemplary embodiment, first angled surface 102 and second angled surface 118 are substantially similarly angled such that V-Shaped groove 130 is substantially symmetrical. In accordance with an aspect of an exemplary embodiment, groove bottom angle 136 may be defined by an angle of between about 10° and about 20°. In accordance with another aspect, groove bottom angle 136 may be defined by an angle of about 15°.

A weld nugget zone 140 is defined between apex 138 and groove opening 132. In accordance with an aspect of an exemplary embodiment, weld nugget zone 140 includes a depth of between about between about 2.5 mm and about 6 mm. Weld nugget zone 140 receives metal from a filler wire 148 as well as weld metal from each of differential barrel component 80 and ring gear component 82.

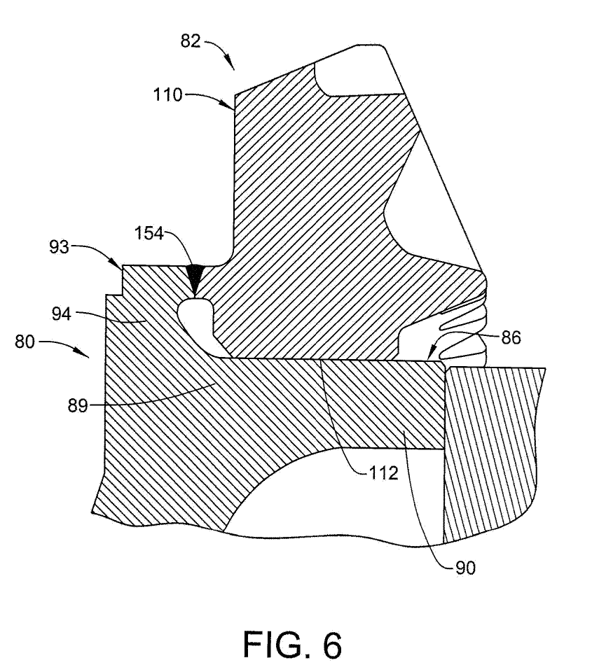

In accordance with an aspect of an exemplary embodiment, filler wire 148 includes an outer diameter 150 having a dimension that is selected to be less than the selected dimension 134 of groove opening 132. In this manner, filler wire 148, when heated through a metallurgical bonding process, such as laser welding, will combine with the weld metal to substantially completely fill weld nugget zone 140 from apex 138 to groove opening 132 forming a weld 154 shown in FIG. 6. Maintaining outer diameter 150 of filler wire 148 at a dimension that is less than the selected dimension 134 of groove opening 132, filler metal will more fully bond with both cast iron of differential barrel component 80 and carbonized steel of ring gear component 82 to ensure desirable welding results thereby reducing manufacturing delays, maintenance, and enhancing consumer satisfaction.

The terms “about” and “substantially” are intended to include the degree of error associated with measurement of the particular quantity based upon the equipment available at the time of filing the application. For example, “about” can include a range of ±8% or 5%, or 2% of a given value.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A system of components comprising:
a first component including a first joint portion; and
a second component including a second joint portion abutting the first component, at least one of the first and second components being formed from cast iron, wherein the first joint portion and the second joint portion, when aligned, form a V-Shaped groove having a groove opening, a groove bottom angle of between about 10° and about 20° and a weld nugget envelope defined therebetween, the groove opening being wider than an outer diameter of a filler wire employed to form a metallurgical bond between the first component and the second component.

2. The system of components according to claim 1, wherein the weld nugget zone is between about 2.5 mm and about 6 mm.

3. The system of components according to claim 1, wherein the groove bottom angle is about 15°.

4. The system of components according to claim 1, wherein the first component defines a differential barrel component and the second component defines a ring gear component.

5. The system of components according to claim 4, wherein the ring gear component is formed from carbonized steel.

7. The system of components according to claim 1, wherein the V-Shaped groove is substantially symmetrical.

8. A vehicle differential comprising:
a differential barrel component including a first joint portion, the differential barrel component being formed from cast iron;
a ring gear component mounted to the differential barrel component, the ring gear component including a second joint portion, wherein the first joint portion and the second joint portion, when aligned, form a V-Shaped groove having a groove opening, a groove bottom angle of between about 10° and about 20° and a weld nugget envelope defined therebetween, the groove opening being wider than an outer diameter of a filler wire employed to form a metallurgical bond between the first component and the second component.

9. The vehicle differential according to claim 8, wherein the weld nugget zone is between about 2.5 mm and about 6 mm.

10. The vehicle differential according to claim 8, wherein the groove bottom angle is about 15°.

11. The vehicle differential according to claim 8, wherein the V-Shaped groove is substantially symmetrical.

12. A method of joining a system of components comprising:
adjoining a first component including a first joint portion with a second component having a second joint portion, at least one of the first and second components being formed from cast iron;
aligning the first joint portion with the second joint portion forming a V-Shaped groove having a groove opening, a groove bottom angle of between about 10° and about 20° and a weld nugget envelope defined therebetween;
inserting a filler wire having an outer diameter smaller than the groove opening into the V-Shaped groove; and
metallurgically bonding the first component to the second component including melting the filler wire into the V-Shaped groove.

13. The method of claim 12, wherein metallurgically bonding the first component to the second component includes welding a ring gear component formed from carbonized steel to a differential barrel component formed from cast iron.

14. The method of claim 12, wherein aligning the first joint portion with the second joint portion includes forming the weld nugget zone with a depth of between about 2.5 mm and about 6 mm.

15. The method of claim 12, wherein forming the V-Shaped groove includes forming a substantially symmetrical V-Shaped groove.
